(19) United States
(12) Patent Application Publication
(10) Pub. No.: US 2013/0015826 A1
(43) Pub. Date: Jan. 17, 2013

(54) Permanent magnet multipole alternator for electrical energy generation systems

(71) Applicant: Dante Imoli, Montebelluna (IT)

(72) Inventor: Dante Imoli, Montebelluna (IT)

(21) Appl. No.: 13/637,352

(22) PCT Filed: May 26, 2011
(86) PCT No.: PCT/EP2011/058680

§ 371 Date: Oct. 1, 2012

(30) Foreign Application Priority Data
May 27, 2010 (IT) VE2010A000026

(51) Int. Cl. H02P 9/04; H02K 29/03; H02K 21/22

(52) U.S. Cl. 322/28; 310/68 D

(57) ABSTRACT

A permanent magnet multipole alternator includes an external rotor mechanically connectable to a source of variable velocity and having permanent magnets, an internal stator having windings housed in slots defined by equidistant teeth terminating in projecting extension pieces, a circuit converting the alternating current generated by the alternator into substantially direct current, and a circuit controlling the rotational speed of the energy source based on load. The conversion circuit has a bridge rectifier circuit, the permanent magnets of the rotor are of approximately trapezoidal shape, the distance between the magnets and the extension pieces of the stator teeth is between 0.8 and 1.8 mm, the ratio between the lengths of the major and minor bases of each magnet is between 1.2 and 6, and the ratio between the length of each extension piece of the stator teeth and the distance between the magnets, is between 0.5 and 2.

### FIELD OF THE INVENTION

The present invention relates to a permanent magnet multipole alternator for electrical energy generation systems, such as electricity generating units, wind generators and the like.

### BACKGROUND OF THE INVENTION

Electricity generating units are known for generating a d.c. voltage to be used for example for battery chargers. They comprise an internal combustion engine of variable or non-variable rotational speed, an alternator provided with an excitation winding and driven by said internal combustion engine, a rectifier circuit for the alternating current generated by said alternator, a system for adjusting the alternator excitation on the basis of the load applied to the rectifier circuit, and a possible system for adjusting the engine rotational speed on the basis of the load.

Although from a theoretical viewpoint these known electricity generating units have proved satisfactory and are widely used, from the practical aspect they present a series of drawbacks, consisting particularly of their considerable weight and the large size of the alternator, and the need to provide an electronic circuit for controlling its excitation.

Electricity generating units are also known comprising an internal combustion engine of variable rotational speed, an alternator without excitation windings but using permanent magnets, preferably of ceramic material or rare earths, an electronic circuit for converting the alternating current generated by said alternator into direct current, and a possible system for controlling the rotational speed of the internal combustion engine on the basis of the load applied to the electronic conversion circuit.

These known electricity generating units have virtually eliminated the drawbacks encountered in the previously described type, but have introduced a further important drawback, related to their constructional complexity, their reliability and the consequently high cost of the electronic conversion circuit which, inter alia, is a source of electromagnetic disturbance.

### SUMMARY OF THE INVENTION

An object of the invention is to also eliminate these drawbacks by proposing a permanent magnet multipole alternator to be coupled to a mechanical energy source to form electrical energy generation systems, such as electricity generating units, wind generators and the like, which are of simple construction, small overall size, low cost and reliable operation, and use a simple, low-cost electronic conversion circuit which produces very low electromagnetic disturbances and which by virtue of a limited generated voltage crest factor, makes it possible to rapidly vary the r.p.m. of the internal combustion engine between its minimum and maximum rotational speed.

This and other objects which will be more apparent from the ensuing description are attained, according to the invention, by a permanent magnet multipole alternator as described hereinafter.

### BRIEF DESCRIPTION OF EMBODIMENTS OF THE INVENTION

A preferred embodiment of the present invention is further clarified hereinafter with reference to the accompanying drawings, in which:

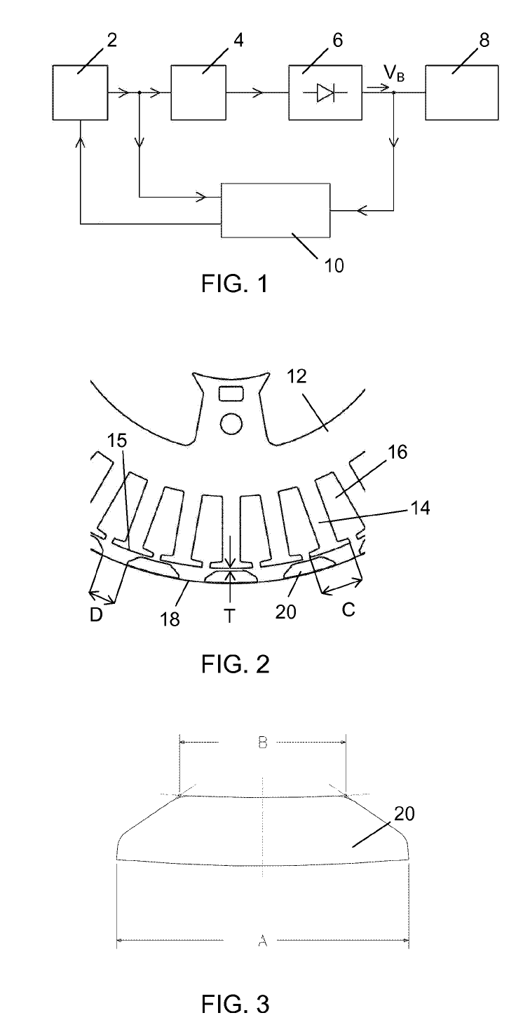

FIG. 1 shows a block diagram of an electricity generating unit according to the invention,

FIG. 2 is a section perpendicular to the axis of rotation showing an alternator portion of the electricity generating unit, and

FIG. 3 shows on a larger scale an axial section through one of the magnets applied to the alternator rotor.

### BRIEF DESCRIPTION OF A PREFERRED EMBODIMENT OF THE INVENTION

As can be seen from the figures, the permanent magnet multipole alternator according to the invention pertains to an electricity generating unit and comprises an internal combustion engine 2 rotating an alternator 4 which generates an a.c. voltage feeding a non-controlled bridge rectifier circuit 6. The rectified voltage V_{B} leaving the bridge 6 feeds the load 8, which is variable, and a circuit 10 which controls the rotational speed of the internal combustion engine 2. This control circuit could also be independently powered by the voltage V_{B}.

The alternator 4 is of multipole multi-phase type and comprises an internal stator 12 with a plurality of teeth 14, each terminating in a circumferentially projecting extension piece 15. The teeth are separated by a like number of slots 16 intended to house the windings in which the electromotive force is induced. The alternator also comprises an external rotor 18, to the inner surface of which, facing the expansion pieces 15 of the teeth 14 of the stator 12, a plurality of permanent magnets 20 are applied, advantageously made of rare earths.

The magnets 20 are of approximately rounded-corner trapezoidal shape in cross-section perpendicular to the alternator axis, with the major base of their two bases being curved concentrically to the axis of the alternator and the minor base being either curved concentrically to the alternator axis and hence be concave, or being convex, or being flat and perpendicular to a radius of the alternator.

The ratio between the length of the major base A, which adheres to the inner surface of the rotor 18, and the length of the minor base B, which faces the extension pieces 15 of the stator tooth 14, is between 1.2 and 6, preferably between 1.3 and 1.8.

In addition, the minimum distance T between each magnet 20 and the extension pieces 15 of the tooth 14, measured in the radial direction, is between 0.5 and 1.8 mm, preferably between 0.8 and 1.4 mm, the ratio between the length C of each extension piece 15 of the tooth 14, measured in the circumferential direction, and the distance D between the magnets 20, being between 0.5 and 2, preferably between 0.7 and 1.3.

It has been found experimentally that by virtue of the particular shape of the magnets, their arrangement within the rotor, and their dimensional ratios, the waveform of the voltage generated in each stator winding, which in the case of magnets of constant thickness should reveal the presence of distorting harmonics, presents instead a substantially sinusoidal or rather substantially trapezoidal pattern, to hence, after rectification through a traditional controlled or non-controlled bridge rectifier 6, result in a minimum voltage drop across its ends in passing from idle operation to rated load operation.

By replacing the electronic circuit for converting alternating current into direct current with a non-controlled bridge rectifier 6, electromagnetic disturbances are virtually eliminated, these representing one of the main drawbacks of traditional electronic conversion circuits.

Moreover, if an electronic circuit provided with either a controlled or a non-controlled bridge rectifier is connected to the alternator, with the new solution the waveform of the voltage generated by it, by virtue of the low crest factor and the likewise low voltage drops between full load and idling, enables the internal combustion engine r.p.m. to be varied within ranges more suitable for the application. For example for a battery charger without a controlled bridge rectifier, the r.p.m. change undergone by the internal combustion engine in passing from idling to full load, becomes less large and involves more rapid engine response times such as to make the final output voltage regulation more stable.

In contrast, for an inverter system, a possible final application could be for a larger r.p.m. range than for traditional alternators. The maximum r.p.m. variation for the full load internal combustion engine depends on the maximum voltage withstandable by the constituent power components of the input bridge rectifier. As the output voltage of the alternator without applied loads increases linearly, the alternator sizing is calculated such that its no-load voltage, delivered at engine over speed r.p.m., is withstandable by said power components. For these applications the minimum working r.p.m. of the internal combustion engine depends on that value of the threshold voltage able to energize the electronic circuit. Because of the fact that with the alternator of the invention the voltage drop between idling operation and full load operation remains low, as also hence does the crest factor, the engine can operate within a wider r.p.m. range, enabling the electronic circuit to remain in the energized state. This enables the internal combustion engine to be used at lower r.p.m. values than a traditional alternator when the output power required from the electricity generating unit is nearly zero, to hence reduce both the fuel consumption and the noise emission under these conditions.

Another important advantage obtainable with the invention is that the stator windings can be star-connected while still maintaining minimum voltage drop across their ends in passing from idle operation to rated load operation. This always makes it possible and simple to connect the stator windings to a traditional engine starter device.

The invention claimed is:

1. A permanent magnet multipole alternator for electrical energy generation systems, comprising:
an external rotor mechanically connectable to a mechanical energy source of variable rotational velocity, said external rotor being provided with permanent magnets;
an internal stator provided with windings housed in slots defined by mutually equidistant teeth terminating in radially projecting extension pieces;
an electronic conversion circuit converting an alternating current generated by said alternator into substantially direct current; and
a circuit controlling rotational speed of said mechanical energy source based on load, wherein:
said electronic conversion circuit comprises a bridge rectifier circuit,
the permanent magnets of the external rotor are of approximately isosceles trapezium shape in cross-section and are disposed perpendicular to the a longitudinal axis of said alternator, said permanent magnets having a major base curved concentrically to the longitudinal axis of said alternator and adhering to an inner surface of the rotor, and further having a minor base facing the extension pieces the teeth of the stator,
a distance measured in a radial direction between the permanent magnets and the extension pieces of the stator teeth is between 0.8 and 1.8 mm,
the ratio between a length of the major base and the length of the minor base of each magnet is between 1.2 and 6, and
the ratio between a length of each extension piece of the stator teeth, measured in circumferential direction, and a distance between the permanent magnets, is between 0.5 and 2.

2. The multipole alternator as claimed in claim 1, wherein said electronic conversion circuit comprises a non-controlled bridge rectifier.

3. The multipole alternator as claimed in claim 1, wherein the minor base of each permanent magnet is concave and has an axis substantially coincident with the longitudinal axis of said alternator.

4. The multipole alternator as claimed in claim 1, wherein the minor base of each permanent magnet is perpendicular to a radius of the alternator.

5. The multipole alternator as claimed in claim 1, wherein the minor base of each permanent magnet is convex.

6. The multipole alternator as claimed in claim 1, wherein the permanent magnets are made of rare earths.

7. The multipole alternator as claimed in claim 1, wherein the circuit for controlling the rotational speed of the mechanical energy source is powered by a voltage at an exit of said bridge rectifier circuit.

8. The multipole alternator as claimed in claim 1, wherein the ratio between the length of the major base and the length of the minor base of each magnet is between 1.3 and 1.8.

9. The multipole alternator as claimed in claim 1, wherein a minimum distance between each magnet and a facing extension piece of the stator teeth is between 0.8 and 1.4 mm.

10. The multipole alternator as claimed in claim 1, wherein the ratio between the length of each extension piece of the stator teeth and the distance between the magnets is between 0.7 and 1.3.
